(19) United States
(12) Patent Application Publication
(10) Pub. No.: US 2017/0113148 A1
(43) Pub. Date: Apr. 27, 2017

(54) SYSTEMS AND METHODS FOR FANTASY SKILL CONTESTS INVOLVING STOCHASTIC PREDICTIONS

(71) Applicant: XERAFLOP TECHNOLOGIES INC., Vancouver (CA)

(72) Inventor: Glenn Stacey BALLMAN, Calgary (CA)

(21) Appl. No.: 15/247,718

(22) Filed: Aug. 25, 2016

Related U.S. Application Data
(60) Provisional application No. 62/213,617, filed on Sep. 2, 2015.

(51) Int. Cl. A63F 13/828; A63F 13/792; A63F 13/35

(52) U.S. Cl. CPC A63F 13/828; A63F 13/35; A63F 13/792

(57) ABSTRACT

A skill based fantasy sports game based on stochastic modeling and athlete results in athletic events occurring simultaneously with fantasy game inputs from fantasy game players or algorithms Play can be conducted automatically by computers and stored stochastic algorithms on behalf of players, or by stochastic algorithms developed by computers without human input. Rewards are determined by individual athlete statistics generated in real time from two or more sporting events. Sporting events may comprise different sports. Game play requires a minimum of 20 picks by users. Picks may result in loss of game play tokens or complete elimination. A computer system controls results, iterations, scoring and also manages devices including lasers, cameras, sensors, and other devices mounted in the stadium that record projectile acceleration and position or other game play projectiles or player body movements that in turn automatically start and stop game play in real time.

### RELATED APPLICATIONS

This application claims the benefit of the priority of U.S. patent application Ser. No. 62/213617 filed 2 Sep. 2015, which is hereby incorporated herein by reference.

### TECHNICAL FIELD

The present invention relates to fantasy skill contests (e.g. based on sports and/or the like). Particular embodiments provided systems and methods for fantasy skill contests that qualify and are lawfully exempted by the United States Unlawful Internet Gambling Enforcement Act of 2006 (UIGEA).

### BACKGROUND

Wagering is by definition a game of chance. Fantasy by definition is a game of skill. Prior art that by definition deal with gambling and wagering are thus inherently dealing with a different industry—that being the industry of “chance” games. The States Unlawful Internet Gambling Enforcement Act of 2006 (UIGEA) specifically exempts fantasy sports games, educational games, or any online contest that “ha[ve] an outcome that reflects the relative knowledge of the participants, or their skill at physical reaction or physical manipulation (but not chance), and, in the case of a fantasy or simulation sports game, has an outcome that is determined predominantly by accumulated statistical results of sporting events, including any non-participant's individual performances in such sporting events”.

There is a general desire to provide improved systems and methods for fantasy skill contests (e.g. based on sports and/or the like) that qualify as skill contests and are lawfully exempted by the United States Unlawful Internet Gambling Enforcement Act of 2006 (UIGEA).

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic diagram of a system for fantasy skill contests according to one embodiment of the invention.

FIG. 2 is a schematic diagram of a system for fantasy skill contests according to one embodiment of the invention.

FIG. 3 depicts a graphical user interface for a system for fantasy skill contests according to one embodiment of the invention.

FIG. 4 depicts a graphical user interface for a system for fantasy skill contests according to one embodiment of the invention.

FIG. 5 depicts a graphical user interface for a system for fantasy skill contests according to one embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

1. Legal Qualification as a Game of Skill By Eliminating Chance Based Picks and Enabling Stochastic Inputs and Modeling

Simply creating a game or contest that allows in-event (e.g. in a sporting event) choices does not qualify a game or contest as a game of skill under UIGEA. For example—a single standalone prediction of distance of an American football punt, and the allowance or scoring driven by a single such prediction creates a game of chance.

The specific study and exclusion of specific “chance based” outcomes and introduction of technology that enables the user to study the factors, data and visual aspects of an “about-to-occur sub-event” (e.g. an about-to-occur play in sporting event) enables the predominant factor of success to become skill. Examples of such factors, data and visual aspects of an about-to-occur sub-event include, but are not limited to, the stance of the batter who is about to swing, the position of the running back on the football field just prior to the snap of the football, the speed of the wind gusts in the stadium, or the body temperature of the knee of the quarterback rolling on the field after a play.

A stochastic model is a tool for estimating probability distributions of potential outcomes by allowing for random variation in one or more inputs over time. The random variation is usually based on fluctuations observed in historical data for a selected period using standard time-series techniques.

2. Minimum 20 or more Picks (Iterations) Based Skill Game

A game of chance can allow a single pick or prediction or a small number of picks/predictions (e.g. less than 20) to generate a prize, as the predominant factor is not skill. Careful study has revealed that the number of iterations (tests) required to separate skill from chance is both sport AND play dependent, and requires careful analysis in:
Both their singularity (single pick) and their plurality (picks chosen together).
The minimum number of picks may depend on a sport by sport and play by play basis, given the sport or the specific play contemplated to create a result set that is skill based.
Determination if the prediction of one or more outcomes is predominantly chance or is predominantly skill, and requiring a minimum number of picks to engage the predominance of skill.

For example—Two competitors that grew up playing football start picking/predicting offensive plays and defensive plays in relation to an American football game. They are studying the plays as they occur, and over a period of time Competitor B starts picking more successful outcomes than Competitor A based on his knowledge of the two teams, the conditions he is observing, the player alignment he is observing. Competitor B may, for example, draw heavily on the experience he obtained while coaching football. With a group comprising a sufficient number of predictions/iterations (e.g. 20 or more predictions/iterations) eventually Competitor B wins, and each time the two players play Competitor B tends to win—as long as there are at least 20 predictions/iterations over which Competitor B can demonstrate his superior skill level.

Whether a game is a game of chance or a game of skill can determine whether or not it is legal in many countries and states. Many states allow people to pay money to participate in games of skill, but forbid them from paying to enter games of chance.

In some circumstances, it can be difficult to perceive differences between contests of skill and contests of chance. Sometimes, a contest may have elements of both chance and skill. Whether a particular contest is a contest of chance or a contest of skill may depend on which element is the dominant factor in determining the outcome of the game. Skill can include any of the following:
A learned or developed ability.
Strategy, or tactic.
Physical coordination or strength.
Technical expertise.
Knowledge of the means of accomplishing a task.

3. Prizing as A Legally Qualified Fantasy Game Based on Picks

Prizing that is established and made known to the participants in advance of the contest is a well known legal requirement or fantasy sports contests. Prizing that is driven by the counted number of correct predictions/picks vs. actual events that occur during a sporting event (e.g. on the field) represents a unique aspect, one that embodies the ability to earn prizes on a per prediction/pick basis from a known prize pool, or from a minimum number of predictions/picks that comprises a minimum number (e.g. 20 or greater) of iterations/predictions/picks determinate to create a game of skill and thus separate from a game of chance.

Fantasy sport prizing compliant with UIGEA must be determined in advance of the competition and may not be influenced by the fees or number of participants. To be legally compliant under 2006 (UIGEA), fantasy sports must follow the rule that: “prizes and awards offered to winning participants are established and made known to the participants in advance of the game or contest and their value is not determined by the number of participants or the amount of any fees paid by those participants.” Within this UIGEA requirement, there is the opportunity to provide analysis toward the amount of prize earned on a pick-by-pick (prediction-by-prediction) basis, as one enters the realm of the top “X” number of contestants, where the prize pool is awarded to the top percentage of winners. In other words, based on picks remaining and your current standing an estimated prize earnings total could be provided with a probability that it will be earned. This can be further extended to show across all prize pools that the player is active within—showing levels of estimates prize earnings well before the contests have ended.

4. Team Competition with an Automated Entry System

Aspects of this disclosure provide combined team scoring algorithm whereby the individual team members scores are added together and accumulate points from the athletic games' real world players, thus forming a teams set of points that are then weighted and compared to other team results to determine a winner of the contest.

An automated selection system allows team members and entire teams to set parameters, and a computer system makes the entries in the various contests for the team. It is noted that the team members may not specifically choose contests, nor do the teams specifically choose contests—rather the computer system may make use of parameters to create a matching that enables the contest entries to occur automatically. Criteria for the automated entry engine can include but will not be limited to “number of picks”, time of start or time of conclusion, length of contest, number of team members in the contest and contest entry fees required to participate.

An ability to roll over winnings into new contest entry fees as they are earned will allow teams and players to play uninterrupted while their winning are being re-entered in new contests automatically—thus registering their picks and automatically qualifying them. The automated rollover of winnings into new contests may comprise functionality that reviews the competing teams relative performance levels and determines if the automated entry has a high probability of success.

5. Cancelling and Partial Refunds of Game Tokens

Players may be able to cancel their chosen picks when they see new information forming on the field of play. This cancellation ability forms may provide part of the skill of avoiding incorrect picks and actively interpreting the new information as it is received via audio, video, text or other data streaming means. The cancellation may result in a partial or complete refund of the pick amount. The refund percentage returned may be based on factors such as length of time to actual closing and or number of picks remaining.

6. Automated Control of Game Play Elements and Display Panels

Depending on the situation, the video, the data stream, or the players input interface may be emphasized to the user to enable faster picks or to alert the user that the picking engine has been opened. For example a sound may emit from the display, the mobile phone may buzz or emit a sound, and the video being watched may change to indicate an opportunity to satisfy pick requirements on the “second game” of athletic endeavor that may have picks/predictions placed against it.

By way of example, a user may be making picks/predictions on a certain football game. While that game is in a TV time out, the user's phone buzzes and changes the TV channel to the second game, and modifies the user interface with the data from the second game—allowing the user to quickly make a read of the situation in the second game and make a qualified and skilled pick before changing back to the primary game the user was following.

This automated switching between channels or video streams and game data may also be caused by the user initiating the change to the second game by swiping or tapping the user interface on their mobile phone, with the phone sending a signal to the cloud server, which in turn sends the signal back to the display to change the channel thus again enabling a very quick view of the situation and a qualified and skilled pick by the user. It is envisioned that a swipe to the left or to the right would result in both the user interface and the display channel changing simultaneously.

7. Playing Across Sports or Types of Skilled Contests

In some aspects, a contest may uniquely allow players to compete across sports—thus allowing a single contest to comprise, for example, of a minimum of 2 hockey games, a hockey game and a football game; or in the case of 3 sports a football game, a baseball game and a basketball game. There is no requirement to stay within a sport, or within a time frame (such as an hour, a day, a week or a year). The number of sporting events can range has high as a user wishes, and the time frame can be as long or as short as the user wishes. In addition, the method of completing the minimum number of picks/predictions of skill may be satisfied by non-sporting criteria, such as a trivia question requiring the element of skill to answer. The primary criteria to complete the contest of skill are that the minimum number of skill-based picks/predictions is met.

8. Scoring

Scoring can be customized by the users, and becomes an element of the player choice when reviewing which contests to enter. Scoring may be predominantly tied to actual statistics generated by the athletes involved in the corresponding sporting events, such as, but not limited to, yards gained, yards lost and/or turnovers achieved (in American football), bases obtained (in baseball), assists and/or points (in basketball or hockey), or in play services of the ball. The scoring may be tied directly to the acceleration or the distance the projectile (e.g. ball or puck or the like) has moved. Multipliers or bonuses may be added or subtracted as the scoring occurs to reflect certain weighted emphasis on desired outcomes, such as field goals by kickers, or hat tricks by hockey players, shutouts by goalies, or no hitter games by pitchers. The scoring may be altered or weighted differently given the probabilistic outcome of the event. The probabilistic outcome of the event may be obtained by a number of factors, which may comprise, without limitation:
providing statistics from the entire subset of players/users entering picks/predictions.
the subset of players/users entering picks/predictions on just this specific contest.
the current skill level and historical statistics of the players involved in the athletic event and their relative success while playing against each other.
the historical data set of likely events to occur given the exact same scenario that has occurred historically, and the given probability of the variables being closely related so as to cause a similar outcome.

9. Complete Automation and Elimination of the “Administrator With Responsibilities”

Other prior art describes the need for an “Administrator with Responsibilities”. In some embodiments, there is no Administrator and statistics, scoring, results and contest management may be automated, being driven by sensors, cameras, laser measuring devices and sound wave, sonar or radar triangulation devices mounted within the confines of the stadium, or affixed to flying objects or satellites above or in proximity close enough to precisely measure results in the field of play.

10. Automated Athletic Event Sensing and Control of Contest Entries and Results Through Sensors and measurement of X, Y, and Z axis movement

Sensors that control the game play of the contest may be mounted on athletes, the projectile used in the sport (example ball or puck), under the surface of play (example the floor, or pitchers plate, and in and above the stadium (for example cameras, infrared sensors, sound wave sensors, lasers, and other sensing devices). These sensing devices monitor changes in velocity and speed of the projectiles and of the individual athletes and thus provide the stochastic model inputs being used by players/users who are engaged in the contest.

For example, a pitcher with a sensor mounted in his shoe places his foot on the mound, where a second sensor mounted in the pitchers plate senses the foot has been placed on the plate. This sensor changes the contest play to “nearing close”. As the pitchers arm starts to accelerate, sensors in the pitchers clothing and in the baseball, and lasers monitoring the baseball sense its acceleration. When the sensors detect that the ball passes acceleration of 40 miles per hour (or some other suitable threshold), or senses the ball has left the players hand, or senses the ball has passed home plate, the automated computer system shuts off acceptance of inputs (picks/predictions) from contest players/users.

Another example is the snap of the football by the offensive team in American football. Sensors in the football may sense when the center has approached the football and when his hand is placed on the ball. Both a laser and a camera may be pointed at the football to measure its precise position as the players hand is placed on it for the snap. When the laser or camera detects that the center's hand has moved, or the sensor in the ball detects acceleration, the sensor(s) alert the main computer that then shut down picking from the contest participants/users.

These same sensors may track their distance travelled in an X, Y, and/or Z axis across the field of play, and drive the scoring of the contest. Scoring may be further paired to serial numbers (or other identifiers) of sensors worn by specific athletes, and thus scoring in the contest may be attributed to specific sensor serial numbers and ultimately determine contest winners.

For example a sensor with identification tag 32145 affixed to a football that travels upward (Z axis) 4 meters; then X axis (6 meters) and then Y axis (2 meters) can thus trigger certain success or failure in the contest and can be attributed to a sensor 76429 what was in close proximity to the 32145 football sensor.

11. Stochastic vs Deterministic Skilled Game Play

A process is deterministic if its future is completely determined by its present and past. On the other hand, a stochastic process is a random process evolving in time. Informally, even if one has full knowledge of the state of the system (and it's entire past), you can not be sure of it's value at future times. More formally, a stochastic process is a collection of random variables, X(t) or Xt, indexed by time.

Athletic events are inherently stochastic processes. Games of skill inherently require a minimum number of iterations/predictions/picks to satisfy the predominance of skill. Contests that allow stochastic process decision-making are inherently more skill based than deterministic processes. Thus, the larger the field of informational inputs for the decision maker (example real time sensor movements, video, audio, text and graphic illustration being provided to the user or computer model and/or the like), the more advanced and improved the stochastic modeling can become.

When computers or humans have such advanced and timely inputs, the advantage in a contest can further shift towards the skilled player and away from the player relying on chance.

12. Excerpt from the UIGEA Act of 2006

At a US federal level, fantasy sports is defined and exempted by the Unlawful Internet Gambling Enforcement Act of 2006 (UIGEA). The bill specifically exempts fantasy sports games, educational games, or any online contest that “has an outcome that reflects the relative knowledge of the participants, or their skill at physical reaction or physical manipulation (but not chance), and, in the case of a fantasy or simulation sports game, has an outcome that is determined predominantly by accumulated statistical results of sporting events, including any non-participant's individual performances in such sporting events . . . ”.

However, all prizing should be determined in advance of the competition and can not be influenced by the fees or number of participants. To be compliant, fantasy sports should follow the rule that: “prizes and awards offered to winning participants are established and made known to the participants in advance of the game or contest and their value is not determined by the number of participants or the amount of any fees paid by those participants.”

The formal definition of fantasy sports within UIGEA stipulates that the outcome of a fantasy game should be dependent on multiple sports events (currently multiple trains of thought on if this means multiple games or can also include multiple statistical events within a game), but explicitly does not define the period over which the game must be played. The enactment of UIGEA gave the first legal definition of fantasy sports around which operators could then develop contests.

The prior art, as understood, provides no tying of payout results to individual player performance statistics for predictions that occur within sporting events (as opposed to on the sporting event as a whole). The prior art, as understood, does not split the results across multiple sporting events, and thus does not satisfy the requirement of the law to drive results primarily from player statistics on the field of play. The prior art, as understood, does not limit the choices to those that require skill, and does not contemplate solely skill-based games. The prior art, as understood, does not indicate how it would be able to create cutoff events thus enable the start and the end of the contest. The prior art, as understood, does not consider team (comprising multiple users) and how use displays for multiple players or to display multiple competitions.

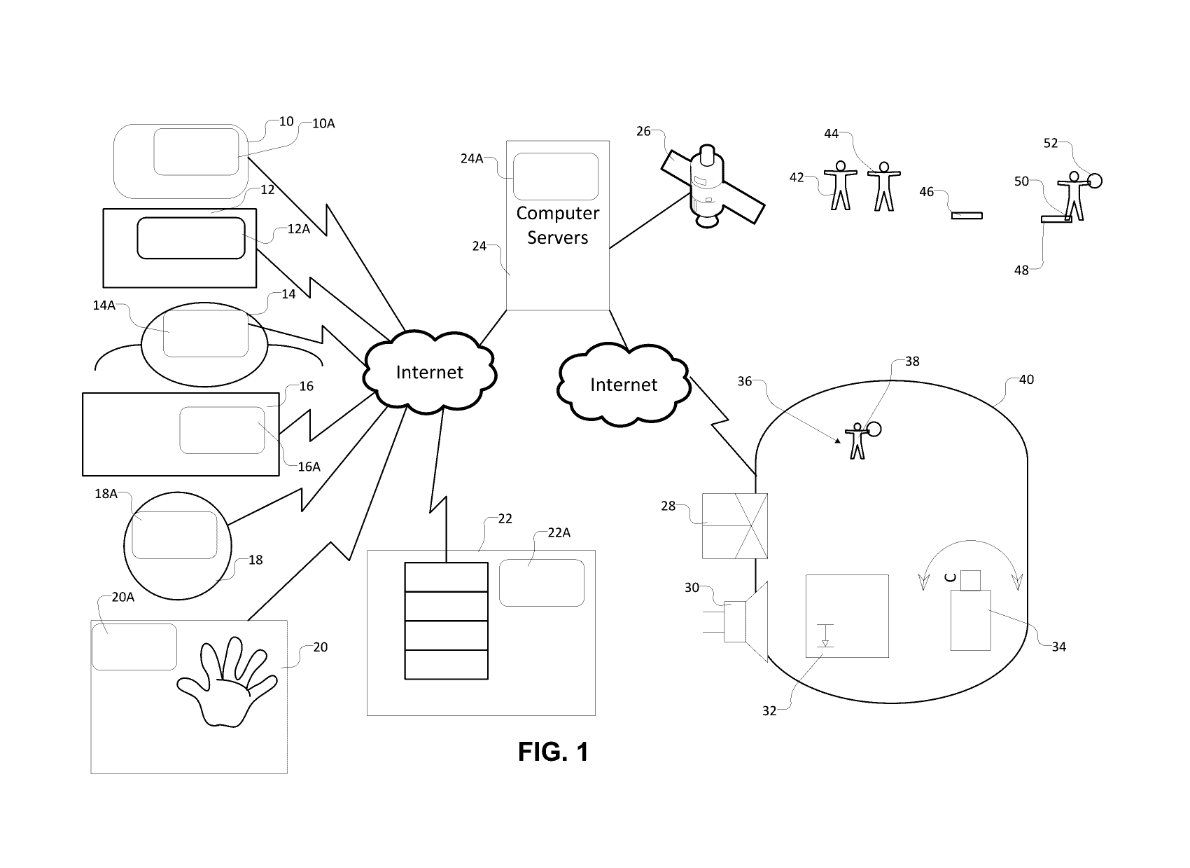

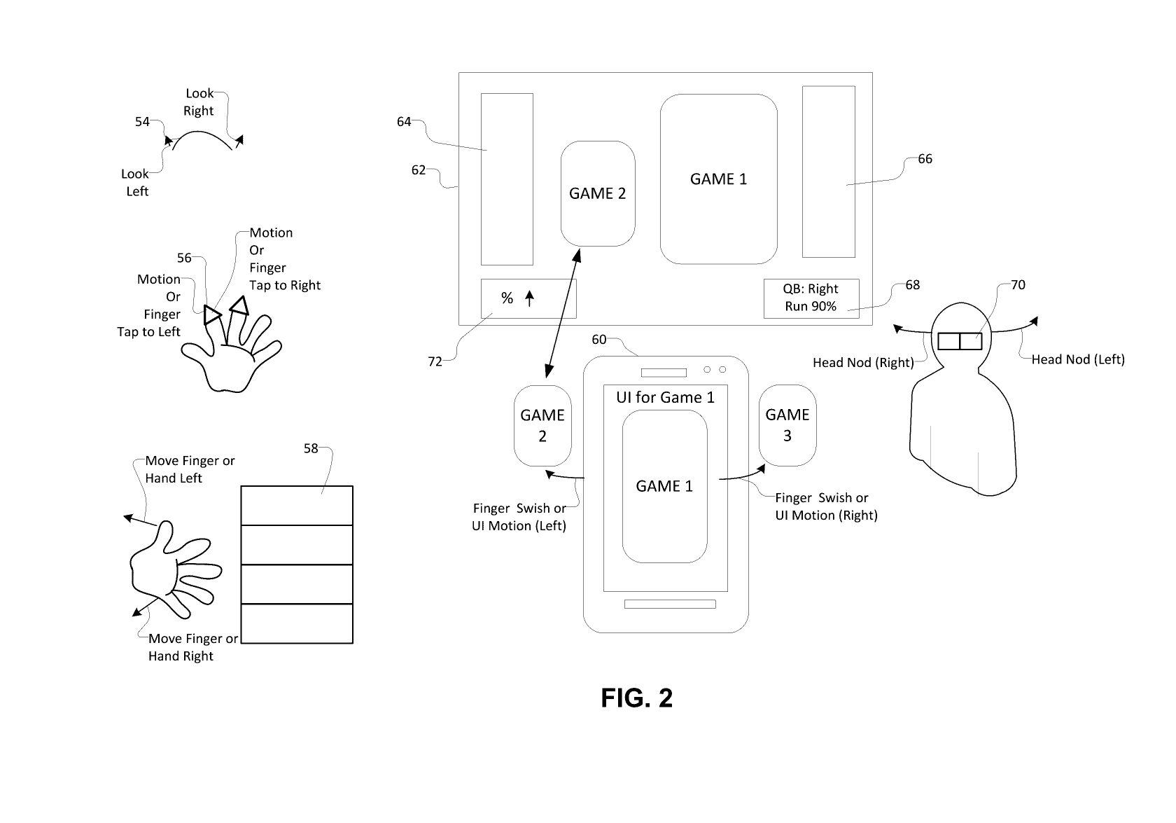

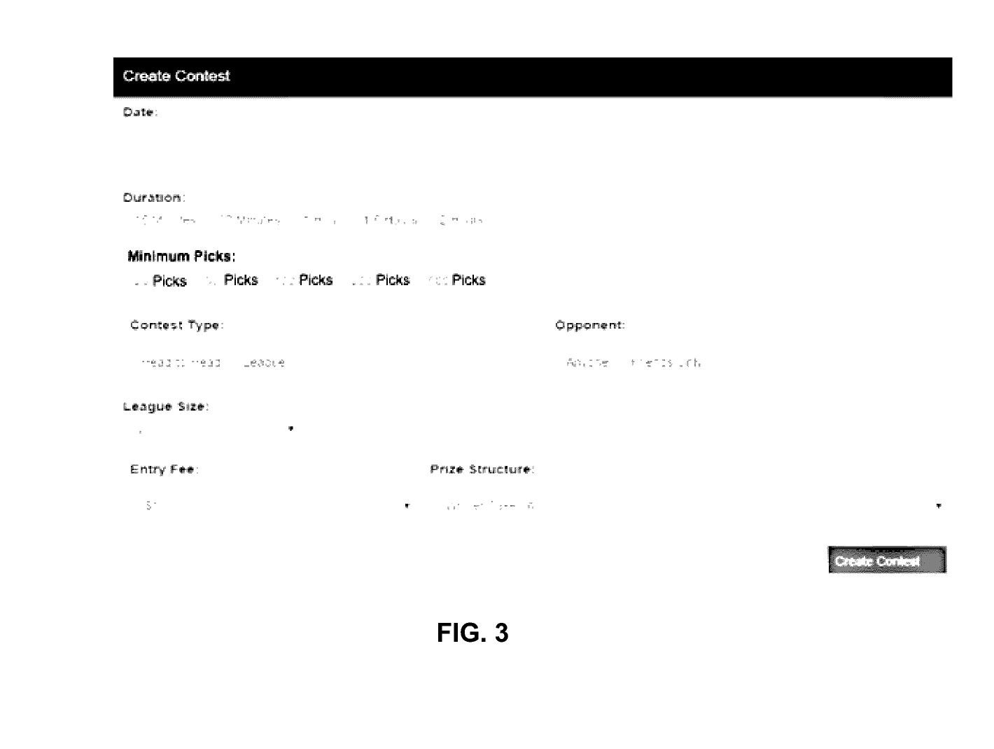

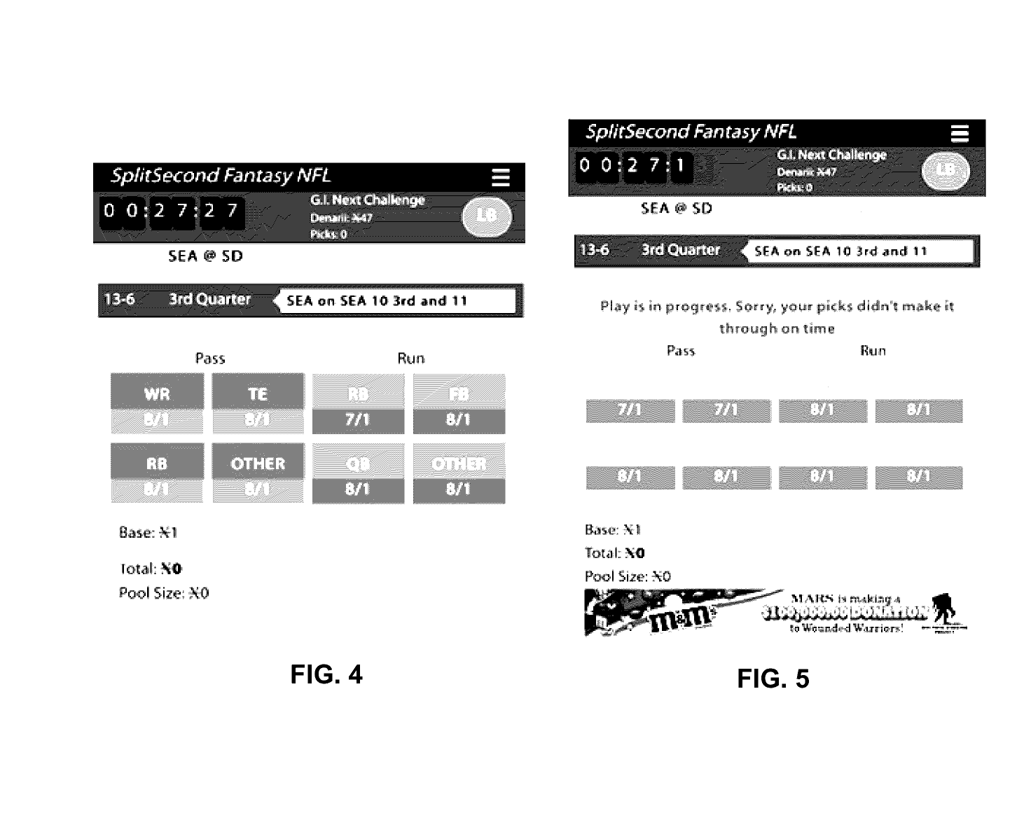

Embodiments of the present disclosure do not require pari-mutuel odds to generate their results, and no prior art can be found where the actual payouts are determined by the direct statistics generated by the athletes in the actual sporting event. The actual display, as shown for a particular embodiment in FIG. 1, illustrates how the display can be modified to show the current number of picks (by all game players in the “small market” limited contest that play being run), number of picks in the entire game play universe “entire market” of that play being run, the amount of points or token on the play being run (contest wide or market wide), and or historical likelihood of that play being run given the historical statistical probabilities of the particular team including the play that has occurred in the last few minutes. These probabilities are driven in real time and are adjusted as different players enter the field of play and become available on the interface. For example—when Quarterback X is on the field, and Wide Receiver Y is substituted in, the probabilities display changes to the likelihood of that particular player combination creating a play result. If a different Quarterback Z is substituted, the probabilities again update to reflect the changed likelihood of certain plays to certain positions. These indicators are useful to game participants who are engaged in the game of skill and it would take far too long to calculate such probabilities in real time. The probabilities or other indicators may or may not be used to generate bonuses depending on the situation. For example, a quarterback that runs, resulting in a loss of yards, will create a loss of “picked” tokens, and the amount may be refunded or actually increase in loss based on the amount of yards lost.

“Bonuses” are not used in standard pari-mutuel wagering. Aspects of the present disclosure provide methods for including bonuses in PBGs and for computing the “odds” on each choice in a way that takes the bonus into account. Bonuses may be a feature in certain aspects of the present disclosure. The bonuses are not just a simple way of giving players extra tokens. The bonuses may inflate the odds on the choices, especially when the betting volume is low. This encourages players to bet early and often.

In some embodiments, scoring is driven by actual player stats being generated by the players/athletes in their game/sporting event play. Odds may be one method to view likelihood of a certain play occurring. Contest scoring may be driven by actual player/athlete results that are occurring in real time in the sporting event.

Particular aspects of the present disclosure are implemented without an administrator and have fully automated open and close times that are driven by sensors in the ball or the athletes, by cameras mounted in the sporting event facility, and by lasers mounted in the sporting event facility pointed at the ball that detect acceleration of the ball from its resting point. This “snap of the ball” in football (measured by acceleration of the ball to X from the scrimmage point or change in position greater than X) or in the case of baseball the acceleration of the “pitch” (measured by the acceleration of the ball) or “stepping on the pitchers plate” (where sensors detect the pitcher has placed his weight on the plate) or in the case of basketball the “release” of the shot from the players hand (by height or by ball speed) or in the case of tennis (the speed of the ball accelerating above X) or in the case of hockey (the speed of the puck accelerating above X) triggers the close of the picking engine, so that users are not able to make further predictions relating to the particular event within the sporting event.

Contests according to particular embodiments are not “betting games”, but rather comprise fantasy sports contests which by law and by definition cannot be a betting game. The distinction between trivia and betting must also be drawn between betting and fantasy sports; and the distinction in scoring based on “almost right” must also be drawn based on scoring derived from “statistics generated by athletes in actual live athletic events”.

In particular embodiments, competition start and end may be determined by a plurality of factors, which may include, without limitation a minimum number of picks/predictions being satisfied, and time having expired. The minimum number of picks/predictions may be 20 or greater in some embodiments and may be greater than 40 in some embodiments. In some embodiments, the split is greater than or equal to 10 picks/predictions on a given sporting event. Players with fewer than the required number of picks may be disqualified from a contest.

Access to the present invention is more easily controlled through a cloud based centralized control software system and network communication over a suitable wide area network (WAN) which is also more automated than under the video broadcast prior art, and unauthorized participants may be more easily excluded from participation.

In some embodiments, the user does not select which groups to join, rather the user selects criteria and/or ranges of criteria that a computer system then uses to do selecting on behalf of the users. Non-limiting examples of criteria include:

the real world athletic events the users wish to base their picks upon (example Jacksonville Jaguars football game and Kansas City Royals baseball game).

the amount of money the users wish to put to in play.

the length of time the users wish to play.

pick minimums or pick maximums the users wish to adhere to. The system then automatically enters them in the contests and puts the money to work in pools that best suit the users' choices.

Finally, in some aspects of the present disclosure, the user sets up “if—then” parameters that are loaded into a custom algorithm, and said algorithm then does the picking automatically for the player. The system does the picking and engages in the game play, and not the player.

Certain implementations of the invention comprise computer processors which execute software instructions which cause the processors to perform one or more methods of the invention. For example, the methods described herein may be implemented by one or more processors which execute software instructions which cause the processor to perform these methods. Such software instructions may be retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The instructions may be present on the program product in encrypted and/or compressed formats.

While a number of exemplary aspects and embodiments are discussed herein, those of skill in the art will recognize certain modifications, permutations, additions and sub-combinations thereof.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A system for fantasy sports contests involving stochastic predictions, the system comprising:
one or more sensors for measuring real-time sub-events in one or more sporting events;
a processor for generating a fantasy skills contest based on the one or more sporting events, the fantasy skills contest comprising:
twenty or more picks by a user wherein the picks relate to the sub-events in the one or more sporting events; and
a payout based on any successful picks and real-time statistics, the real-time statistics based at least in party on the sensor measurements of the sub-events; and
a user interface for receiving the twenty or more picks and for outputting results of the fantasy skills contest.

2. A method for fantasy sports contests involving stochastic predictions, the method comprising:
obtaining sensor data comprising data obtained from sensors configured to sense real-time sub-events in one or more sporting events;
generating a fantasy skills contest based on the one or more sporting events, the fantasy skills contest comprising:
twenty or more picks by a user wherein the picks relate to the sub-events in the one or more sporting events; and
a payout based on any successful picks and real-time statistics, the real-time statistics based at least in party on the sensor measurements of the sub-events; and
a user interface for receiving the twenty or more picks and for outputting results of the fantasy skills contest.

3. A system and/or method comprising any features, combination of features or sub-combination of features described herein and/or in the drawings appended hereto.
